(19) United States
(12) Patent Application Publication
(10) Pub. No.: US 2008/0025213 A1
(43) Pub. Date: Jan. 31, 2008

(54) Network communication device

(75) Inventors: Kazunori Gotou, Osaka (JP); Masaru Satoh, Osaka (JP); Narihiko Suese, Osaka (JP); Yoshiaki Yasui, Osaka (JP); Mitsuhiro Kitamura, Osaka (JP)

Correspondence Address: FOLEY AND LARDNER LLP;SUITE 500, 3000 K STREET NW, WASHINGTON, DC, 20007, US

(73) Assignee: KYOCERA MITA CORPORATION

(21) Appl. No.: 11/878,705

(22) Filed: Jul. 26, 2007

(30) Foreign Application Priority Data
Jul. 27, 2006 (JP) JP 2006-204543

(51) Int. Cl. H04L 12/56; H04L 12/42

(52) U.S. Cl. 370/229; 370/351; 370/449

(57) ABSTRACT

The present invention provides a network communication device that performs data communication by using a network, in which a reception capability at a self-machine side is reported to a transmission source side and this transmission source performs communication by a transmission method matched with the reception capability, comprising: a transmission source identification section for acquiring from received data transmission source identification information for identifying the transmission source; a reception capability setting section for setting the reception capability of a self-machine in accordance with the transmission source identification information; and a reception capability report section for reporting this reception capability to the transmission source by using the reception capability. Therefore, according to the network communication device of the present invention, a proper communication setting is possible by every transmission source, thus realizing a large degree of freedom of modes for use.

### BACKGROUND OF THE INVENTION

1. Technical Field

The present invention relates to a network communication device, and for example, relates to an improvement of the network communication device that treats transmission/reception of data on the Internet.

2. Description of the Related Art

In recent years, various data communications are performed through a network such as Internet. When there is a functional difference between a transmission side device and a reception side device connected to the network, a smooth communication is secured by adjusting a function of either side to the function of the other side until the function of allowing both way communication is achieved. Alternately, the communication has to be limited, in a case of a particular opposite side which is functionally unacceptable.

Japanese Patent Laid Open No. 2004-23215 (patent document 1) can be given as a publicly-known example having this kind of function. According to this publicly-known example, in a communication system using a packet communication network such as Internet, an opposite-side IP address (Internet Protocol Address) and port number are referenced and whether an incoming call is permitted or refused is decided, thereby making it possible to refuse the incoming call from a particular opposite side that possibly causes trouble.

Also, Japanese Patent Laid Open No. 2001-136321 (patent document 2) can be given as another publicly-known example. This publicly-known example has a mechanism that sender telephone number information of an opposite-side machine is detected, the detected sender telephone number information of the opposite-side machine and a reception capability of the opposite-side machine are registered so as to be corresponded to each other, and when the incoming call is received from the same opposite-side, a declaration content of the reception capability is decided. By adopting such a structure, it is possible to switch the content of a reception capability declaration of a self-machine according to a transmission source, and an effective communication is thereby realized.

However, in the aforementioned patent document 1, an incoming-call refusal decision is performed by the opposite-side IP address and port number. Therefore, when the IP address of the opposite-side is not fixed, the network communication device disclosed in the patent document 1 is not suitable for using this IP address for the incoming-call refusal decision.

Meanwhile, according to the patent document 2, the content of the reception capability declaration of the self-machine to the transmission source is switched, by the opposite-side telephone number in a general telephone network, which is difficult to be executed in the same way as the patent document 1 in a communication performed through the network such as the Internet, because there is no way of knowing a telephone number in the packet communication network such as the Internet.

Accordingly, under such a circumstance, it is desired in the IP network to discriminate the opposite-side that performs transmission, realize a communication setting by every transmission source, and provide a communication device at a high degree of freedom for a user.

### SUMMARY OF THE INVENTION

In order to solve the above-described problem, the present invention is provided, and an object of the present invention is to provide a network communication device enabling a proper communication setting by every transmission source, in an IP network.

In order to solve the above-described problem, the present invention provides the network communication device using a communication system in which data communication is performed by using a network, a reception capability at a self-machine side is reported to a transmission source side and the transmission source performs communication by a transmission method matched with the reception capability, including a transmission source identification section for acquiring from received data transmission source identification information for identifying the transmission source; a reception capability setting section for setting the reception capability of the self-machine according to the transmission source identification information; and a reception capability report section for reporting the reception capability to the transmission source by using the reception capability.

Then, the present invention takes several structures as follows.

In one of the structures of the present invention, the present invention realizes a structure that the aforementioned communication system is represented by a facsimile communication that complies with ITU-T recommendations (T.38:ITU-T recommendations T.38).

In another structure of the present invention, an IP address obtained from the received data is set as the transmission source identification information, the host computer name obtained through the IP address is set as the transmission source identification information, this IP address is made to comply with IPv6 (Internet Protocol Version 6), and the reception capability is set by every transmission source identification information.

In still another structure of the present invention, a reception possible recording width, a reception possible recording length, a reception possible encoding system, a reception possible resolution, a reception possible communication speed, or propriety of polling communication is set as the reception capability.

In still another structure of the present invention, as the reception capability, when an individual setting according to the transmission source is not made, the reception capability is set in default, the reception capability is so formed as to output report, and a reception capability setting other than default setting is displayed with emphasis.

In still another structure of the present invention, the incoming call from the transmission source is limited based on the transmission source identification information.

According to the network communication device of the present invention with the above-described structures, the transmission source identification information is acquired by the transmission source identification section from the received data, the reception capability of the self-machine is set in the reception capability setting section according to the transmission source identification information, and this reception capability is reported to the transmission source from the reception capability report section by using the reception capability. Therefore, the proper communication setting is realized by every identified transmission source and a high degree of freedom for use is realized.

In addition, according to the structure that the above-described communication system is represented by the facsimile communication that complies with T.38, the convenience of the user can be improved through a proper communication setting by every transmission source in the facsimile communication.

Further, the transmission source identification information can be set as the IP address obtained from the received data in the facsimile communication, and also can be set as the host computer name based on this IP address. Then, according to the structure that the IP address complies with the IPv6, specific transmission source identification is possible. Therefore, further proper reception capability setting is possible. Namely, in the IPv4 (Internet Protocol Version 4) frequently used as a communication protocol in the Internet at present, an address space, being a memory space accessible by a series of memory addresses, is constituted of 32 bits. In such a structure, there are few IP addresses that can be managed, therefore a fixed address can not be sufficiently assigned, and there is a necessity of taking a measure such as sharing one fixed address. However, in the IPv6, the IP address is constituted of 128 bits, thus making address space large, making it easy to identify an individual communication device.

Further, according to the structure that the reception possible recording width, the reception possible recording length, the reception possible encoding system, the reception possible resolution, the reception possible communication speed, the polling communication propriety, and a default setting are set as the reception capability, a usable range is expanded and the convenience of the user can be further improved.

Further, according to the structure that the reception capability can be outputted as a report and the structure that the reception capability setting other than the setting of the default is displayed with emphasis, the convenience of the user can be improved from the viewpoint of management.

In addition, according to the structure that the incoming-call from the transmission source is limited based on the transmission source identification information, the incoming call from an unnecessary transmission source can also be limited.

### BRIEF DESCRIPTION OF THE DRAWINGS

FIG. 1 is a block diagram showing an embodiment of a network communication device according to the present invention.

FIG. 2 is a view showing an example of a reception capability table according to the present invention.

FIG. 3 is a flowchart explaining an operation of the network communication device of FIG. 1.

### DESCRIPTION OF PREFERRED EMBODIMENTS OF THE INVENTION

Preferred embodiments of the present invention will be explained with reference to the drawings.

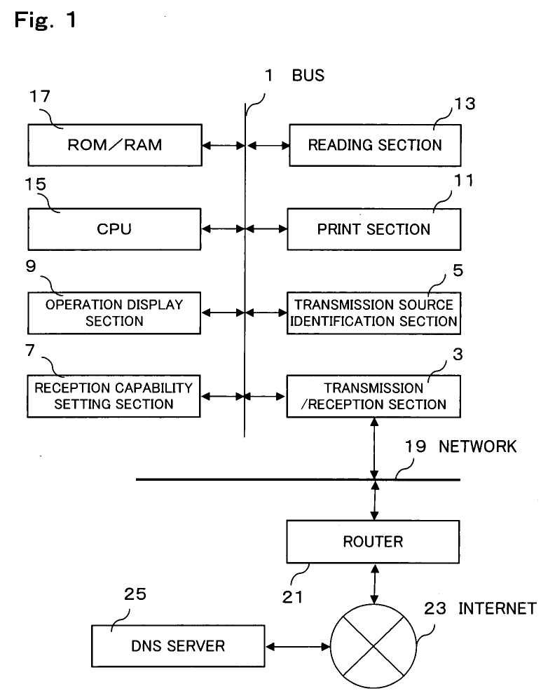

FIG. 1 is a block diagram showing a network communication device according to the present invention, showing an internet facsimile device as an example.

In this internet facsimile device of FIG. 1, a transmission/reception section 3, a transmission source identification section 5, a reception capability setting section 7, an operation display section 9, a print section 11, a reading section 13, and a ROM/RAM 17 are connected to a CPU 15 via a bus 1, and mainly under this CPU 15, the transmission/reception section 3, the transmission source identification section 5, the reception capability setting section 7, the operation display section 9, the print section 11, and the reading section 13 are operated.

The transmission/reception section 3 is connected to Internet 23 via a publicly-known router 21 from a network 19 such as an in-house LAN, and has a function of communicating data with an external computer not shown by a facsimile communication system that complies with T.38, and also has an interface function of performing transmission/reception of electronic data based on IPv6 (Internet protocol version 6), and the received data is outputted to the transmission source identification section 5 and the reception capability setting section 7, etc.

Based on an instruction from the transmission source identification section 5 as will be described later, the transmission/reception section 3 inquires a host computer name (transmission source) to a DNS (Domain Name System) server 25 by using a PTR (PoinTeR) via the router 21 and the Internet 23. Then, the transmission/reception section 3 has a function of transmitting a reception capability setting content from the reception capability setting section 7, to the transmission source via the network 19, after the host computer name (transmission source) is acquired.

Under a control of the CPU 15, the transmission source identification section 5 acquires the IP address from a TCP packet of the received data, for example, at the time of the incoming call of the received data. Also, the transmission source identification section 5 has a function of controlling to acquire this host computer name, after inquiring the host computer name to the DNS server 25 by controlling the transmission/reception section 3, with this IP address as the transmission source identification information.

Further, the transmission source identification section 5 has a function of identifying the transmission source by every host computer name, when the host computer name is obtained via the transmission/reception section 3, namely, the function of forming the transmission source identification information by every host computer name in a table shape, and storing it in the ROM/RAM 17, for example. This transmission source identification information will be described later.

It is also possible for the transmission source identification section 5 to form, store, and control the transmission source identification information by every IP address and acquire the transmission source identification information based on the IP address that complies with various standards such as the IPv4 other than the IPv6. Note that the IPv6 and the IPv4 are protocols positioned in a network layer, in an OSI (Open Systems Interconnection) reference model established by the ISO (International Organization for Standardization). The IPv6 and the IPv4 have different network address lengths, such as v6 being 128 bits, and v4 being 32 bits.

The reception capability setting section 7 has a function of setting the reception capability of a self-machine by every transmission source identification information, and outputting the reception capability of the self-machine to the transmission/reception section 3.

As the reception capability set by the reception capability setting section 7, examples are given such as a reception possible recording width (width dimension) per every one page of data received by the aforementioned facsimile communication, an overall reception possible recording length (reception capacity), a reception possible encoding system (data compression system), a reception possible resolution, a reception possible communication speed, and further propriety of polling communication for automatically receiving facsimile data from the host computer by a self-machine side operation.

Specifically, as the reception possible recording width, the width of a paper is sometimes expressed by A4 size or A3 size. The reception possible recording length (reception capacity) is a length expressed by Unlimited or Limited, etc. The reception possible encoding system is a data compression system such as JBIG (Joint Bi-level Image experts Group), and the reception possible resolution is the number of lines per every one inch, such as 600 dpi or 300 dpi.

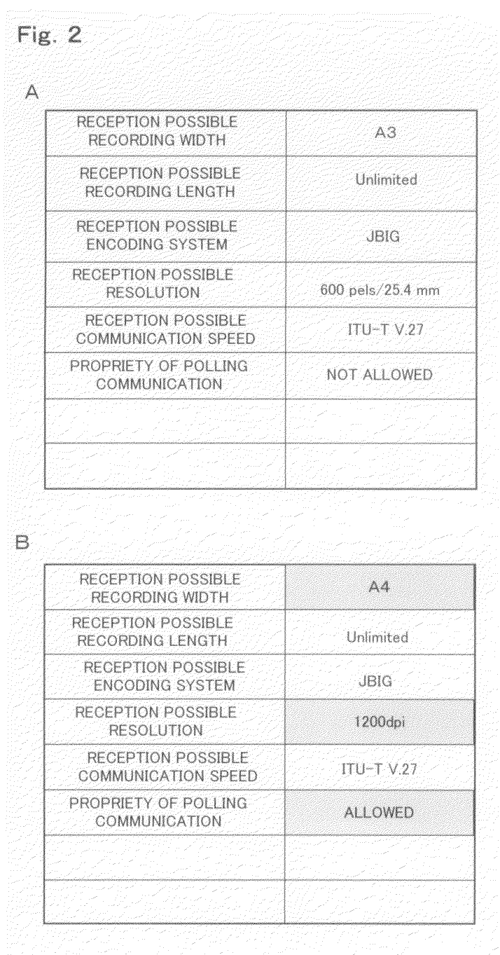

As shown in FIG. 2A, for example, by automatic setting or the setting from the operation display section 9, the reception possible setting section 7 prepares the reception capability in a table shape by every transmission source identification information, and stores it in the ROM/RAM 17, for example, and controls to output the set reception capability corresponding to the transmission source identification information, to the transmission/reception section 3 of the acquired transmission source. Note that when the reception capability of the self-machine is lower than the received data, a self-machine capability close to the received data is set.

When the individual reception capability is not set by every transmission source identification information, the reception capability setting section 7 has a function of setting previously set reference values or conditions (default) of the self-machine.

As the default, the following values are given as examples.
(1) Reception possible recording width (width dimension): A3
(2) Overall reception possible recording length (reception capacity): Unlimited
(3) Reception possible encoding system (data compression system): JBIG (Joint Bi-level Image experts Group)
(4) Reception possible resolution: 600 pels/25.4 mm 600 lines/25.4 mm(600 dpi×600 dpi)
(5) Reception possible communication speed: ITU-T V.27 ter, V.29, and V.17

The reception capability setting section 7 is in a state possible to output the table-shaped reception capability by every transmission source identification information and output the report. Particularly as shown in FIG. 2B, the reception capability setting section 7 is in a state that the reception capability setting other than the default setting is displayed with emphasis. In FIG. 2B, the reception possible recording width, the reception possible resolution, and the reception possible communication speed are emphasized.

The reception capability setting section 7 has a function of refusing the incoming call from the transmission source or limiting the incoming call of the transmission/reception section 3 so as to limit a part of the aforementioned reception contents, based on the transmission source identification information.

The operation display section 9 serves as, for example, a liquid crystal touch type operation display panel (not shown) disposed in a body case of an electronic device on which the data transmission/reception device of the present invention is mounted. On this operation display section 9, table-shaped setting of the reception capability by every transmission source identification information, the reception capability report, and others are displayed.

The print section 11 serves as a conventionally known print engine for printing the table-shaped reception capability report by every transmission source identification information or the received data (received facsimile document), and of course it can be formed to automatically print the received data even if no print instruction is given.

The reading section 13 is conventionally known, whereby an original to be facsimile-transmitted, for example, is optically read, converted into electronic data, converted into a specified transmission form, and is outputted to the transmission/reception section 3.

As described above, the transmission/reception section 3 has a function of reporting to the transmission source address in the network 19 the reception capability content from the reception capability setting section 7, and the transmission/reception section 3 functions as a reception capability report section for reporting outside the set content by using the set reception capability content.

The CPU 15 has a function of controlling to perform data transmission/reception by the transmission/reception section 3, and a function of controlling to acquire and inquire the transmission source identification information by the transmission source identification section 5, set the reception capability of the self-machine by every transmission source identification information by the reception capability setting section 7, and report the reception capability of the self-machine, and so forth.

The ROM/RAM 17 have a function of storing an operation program of the CPU 15 and temporarily storing the data which is being operated by the CPU 15, and also storing the table-shaped reception capability by every transmission source identification information, and individual setting information (including default) such as reception possible recording width, reception possible recording length, reception possible encoding system, reception possible resolution, and reception possible communication speed, which are the source of the setting, and read/write is controlled under the control of the CPU 15.

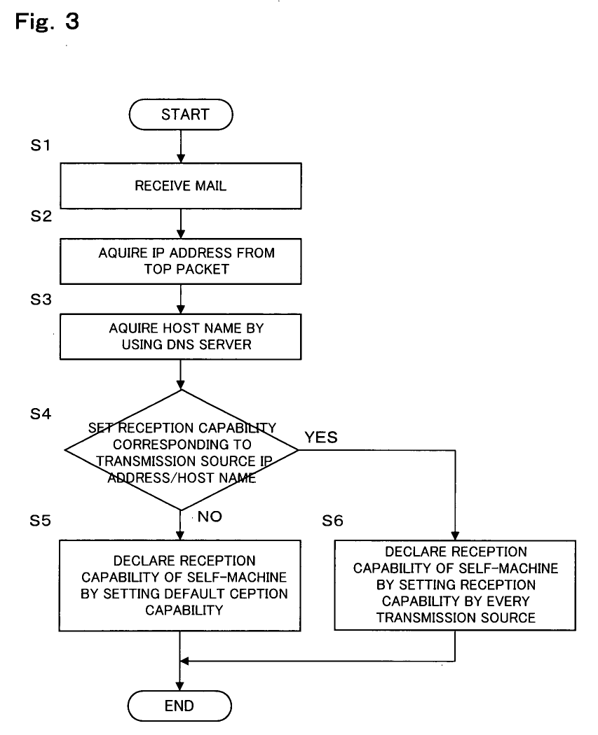

Next, an operation of the network communication device according to the present invention will be simply explained with reference to a flowchart of FIG. 3. Note that a default reception capability or an individual reception capability by every transmission source is previously set by every transmission source.

In step S1, when the transmission/reception section 3 receives a mail from the network 19, the transmission source identification section 5 acquires the IP address from the TCP packet in step S2, and the transmission source identification section 5 acquires the host computer name from the IP address by using the DNS server 25, and the processing is moved to step S4.

In step S4, the reception capability setting section 7 decides whether or not there is the reception capability setting by every transmission source corresponding to the IP address of the transmission source or the host computer name.

If NO in step S4, because the reception capability by every transmission source is not set, the reception capability setting section 7 declares a default reception capability as the reception capability of the self-machine in step S5 and ends the processing. Meanwhile if YES in step S4, because there is the reception capability setting by every transmission source, the reception capability setting section 7 declares the set reception capability by every transmission source as the reception capability of the self-machine and ends the processing in step S6.

Thereafter, this reception capability is reported to the transmission source side by using the reception capability of the self-machine side, and this transmission source designates a transmission method matched with the reception capability and for example an internet/facsimile communication is performed with the self-machine.

Thus, the network communication device according to the present invention is the network communication device in which the reception capability at the self-machine side is reported to the transmission source side and this transmission source uses a communication transmission method matched with the reception capability, including the transmission source identification section 5 for acquiring the IP address obtained from the received data and the transmission source identification information to discriminate and identify the transmission source based on the host computer name obtained from this IP address; the reception capability setting section 7 for setting the reception capability of the self-machine by every transmission source identification information; and the transmission/reception section (reception capability report section) 3 for reporting this reception capability to the transmission source by using the set reception capability.

Therefore, according to the present invention, for example, in the facsimile communication via the IP network, it is possible to specifically automatically identify the opposite-side that performs transmission, thus realizing a proper facsimile communication setting by every transmission source and enhancing the degree of freedom and the convenience of the user via the proper communication setting by every transmission source.

Namely, according to the present invention, transmission/reception of accurate contents is possible between the transmission source and the transmission destination, thus hardly allowing a case that the transmission/reception can not be performed, a part of the contents of the transmission/reception lacks, or the transmission/reception is erroneously performed.

In addition, according to the present invention, the aforementioned transmission source identification information can be acquired from the IP address obtained from the received data, and by setting the host computer name obtained through the IP address as the transmission identification information or by making this IP address comply with the IPv6, a specific transmission source identification is realized. Therefore, a use range is expanded and usability of the user can be improved.

Further, according to the present invention, the reception possible recording width, the reception possible recording length, the reception possible encoding system, the reception possible resolution, the reception possible communication speed, the propriety of the polling communication, and the default mode can be set as the reception capability. Therefore, the use range is similarly expanded and the usability of the user can be improved.

Still further, according to the present invention, the reception capability can be outputted and reported, and a reception capability setting item other than the default setting can be displayed with emphasis. Therefore, the usability of the user can be improved from the viewpoint of management operation.

In addition, according to the present invention, based on the transmission source identification information, the incoming call from the transmission source can be limited. Therefore, the control is possible such as refusing the incoming call from the unnecessary transmission source or limiting the incoming call partially.

As described above, the network communication device according to the present invention can be applied not only to the facsimile communication via the IP network that complies with the T.38, but also to document data that is transferred in a network, a print job, and other wider range of electronic data.

Particularly, in the internet/facsimile communication, a general structure is that various document data is automatically transmitted or received. Therefore, automatic setting by the network communication device of the present invention is particularly useful.

1. A network communication device that performs data communication by using a network, in which a reception capability at a self-machine side is reported to a transmission source side and this transmission source performs communication by a transmission method matched with said reception capability, comprising:
a transmission source identification section for acquiring from received data transmission source identification information for identifying said transmission source;
a reception capability setting section for setting said reception capability of a self-machine in accordance with said transmission source identification information; and
a reception capability report section for reporting this reception capability to said transmission source by using said reception capability.

2. The network communication device according to claim 1, wherein said communication system is a facsimile communication that complies with T.38.

3. The network communication device according to claim 1, wherein said transmission source identification information is an IP address obtained from said received data.

4. The network communication device according to claim 3, wherein said transmission source identification information is a host computer name obtained via said IP address.

5. The network communication device according to claim 3, wherein said IP address complies with IPv6.

6. The network communication device according to claim 1, wherein said reception capability is set for said each transmission source identification information.

7. The network communication device according to claim 2, wherein said reception capability is a reception possible recording width.

8. The network communication device according to claim 2, wherein said reception capability is a reception possible recording length.

9. The network communication device according to claim 1, wherein said reception capability is a reception possible encoding system.

10. The network communication device according to claim 1, wherein said reception capability is a reception possible resolution.

11. The network communication device according to claim 1, wherein said reception capability is a reception possible communication speed.

12. The network communication device according to claim 1, wherein said reception capability is a propriety of a polling communication.

13. The network communication device according to claim 1, wherein said reception capability is set in default when an individual setting according to said transmission source is not performed.

14. The network communication device according to claim 1, wherein said reception capability is so formed as to output report.

15. The network communication device according to claim 14, wherein said reception capability other than setting of said default is displayed with emphasis.

16. The network communication device according to claim 1, wherein incoming call from said transmission source is limited based on said transmission source identification information.
